(19) United States
(12) Patent Application Publication
(10) Pub. No.: US 2007/0271745 A1
(43) Pub. Date: Nov. 29, 2007

(54) Quick Release Clamp Apparatuses, Methods and Systems

(76) Inventor: Robert M. Frey, Salt Lake City, UT (US)

Correspondence Address: PATENT GROUP 2N;JONES DAY, NORTH POINT, 901 LAKESIDE AVENUE, CLEVELAND, OH, 44114, US

(21) Appl. No.: 11/683,429

(22) Filed: Mar. 7, 2007

Related U.S. Application Data
(60) Provisional application No. 60/743,428, filed on Mar. 7, 2006.

(51) Int. Cl. F16B 2/18

(52) U.S. Cl. 24/568

(57) ABSTRACT

A quick release clamp for connecting a first tube section to a second tube section that is perpendicularly oriented to the first tube section. One embodiment includes an upper plate, a lower plate, a handle, a threaded fastener, and a threaded receiver. The handle and the threaded fastener engage the upper plate, the lower plate and the threaded receiver so that the first tube section and the second tube section are secured within the clamp between the upper and lower plates in a perpendicular orientation relative to each other.

### CROSS-REFERENCES TO RELATED APPLICATIONS

This application claims the benefit of U.S. Provisional Application Ser. No. 60/743,428 filed Mar. 7, 2006 which is incorporated herein by reference in its entirety.

### STATEMENT REGARDING FEDERALLY SPONSORED RESEARCH OR DEVELOPMENT

None.

### REFERENCE TO SEQUENCE LISTING, A TABLE, OR A COMPUTER PROGRAM LISTING COMPACT DISK APPENDIX

None.

### BACKGROUND

1. Field of the Invention

The invention relates to clamps for connecting sections of tubing with other tubing, particularly for connecting sections of hollow, cylindrical, metal tubing which are perpendicularly oriented to each other.

2. The Related Art

Clamps of the present invention can be used with a variety of products which use hollow, cylindrical tubing made of metal or other materials. These products include television stands, infant seats, and trade show displays, and tube clamps are known in the art to rigidly join the tube sections in these products.

One type of tubing that is widely used is fabricated in a cylindrical form from sheet metal and has an internal, longitudinal seam of overlapping, folded sheet metal. While conventional clamps in use today can be used with such internal seamed tubing, such conventional clamps do not accommodate this type of tubing in a manner that permits the tube section to be attached or detached to another perpendicular tube section without using conventional tools.

There is a need for an inexpensive and visually appealing device and method to fasten a hollow tube segment with a perpendicular oriented tube securely and without the use of tools. For example, in many environments where display assemblies and systems are used, the use of tools to connect the displays requires that a local union perform all display system assembly and erection which can be costly and can delay the setup. Other clamps use snap fit connections which use a male/female clamp and a pin. One problem with these clamps is that the connections between the tube members are not secure or rigid.

### BRIEF DESCRIPTION OF THE DRAWINGS

In the accompanying drawings forming part of the specification, in which like numerals are employed to designate like parts throughout the same,

FIG. 1 is a component view of an embodiment of the claimed subject matter;

FIG. 2 is perspective side view of an embodiment of the claimed subject matter in an engaged position; and

FIG. 3 is perspective side view of an embodiment of the claimed subject matter shown in use to connect two perpendicular tube members.

### SUMMARY

Embodiments of the quick release clamps are easily installed, fastened and unfastened without the need to use conventional tools. Embodiments also allow for quick adjustment of one or both of the tube sections being connected so that the tube sections can be moved to different orientations. For example, the clamp may accommodate a tube section which may be released and engaged as necessary to properly orient other structures, such as casters, that are mounted to one of the tube sections, and then quickly locked into place.

One embodiment is a clamp assembly for connecting a first tube section to a second tube section perpendicularly oriented to the first tube section. This embodiment includes an upper plate, a lower plate, a handle, a threaded fastener, and a threaded receiver. The handle and the threaded fastener engage the upper plate, the lower plate and the threaded receiver so that the first tube section and the second tube section are secured within the clamp between the upper and lower plates in a perpendicular orientation relative to each other.

### DETAILED DESCRIPTION OF THE EMBODIMENTS

In the following description, numerous specific details are set forth, such as connector apparatuses used with supports and tubular structures, to provide a thorough understanding of the various embodiments of the claimed subject matter. One skilled in the relevant art will recognize, however, that these embodiments can be practiced without one or more of the specific details, or with other methods or components.

References throughout this specification to “one embodiment” or “an embodiment” means that a particular feature, structure, or characteristic described in connection with the embodiment is included in at least one embodiment of the present claimed subject matter. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It will be noted here that for a better understanding the components are designated by like reference numerals throughout the various figures in the embodiments wherein the following components are:
a quick release tube clamp 10;
an upper plate 12;
a lower plate 16;
a handle 20;
a threaded fastener 22;
a threaded receiver 24;
a saddle nut 26; and
a tube member 28.

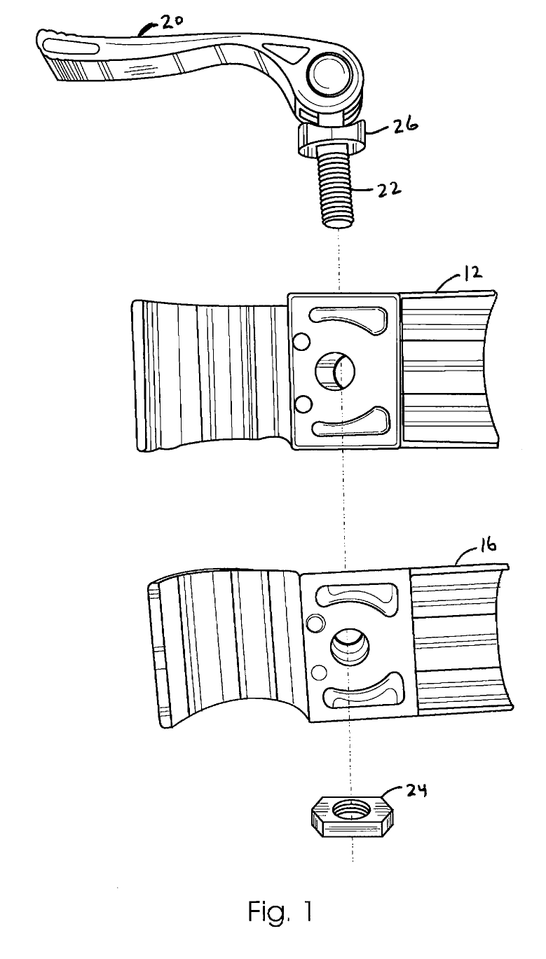

Referring now to FIG. 1, the illustration shows a component view of an embodiment which can be used to join or connect a first tube section to a second tube section which is perpendicularly oriented to the first tube section. In other embodiments, the clamp may be permanently connected to an article or a tube section and the clamp may connect that tube or article to a single hollow tube section. The illustrated embodiments can also be used with any solid or hollow tubes sections or members. Further, the embodiments of the claimed subject matter are illustrated as being used with cylindrical tube sections that can be used with conventional tubing products, but embodiments may also be adapted to other shapes or configurations in order to connect or join non-cylindrical tube sections.

For example, the tubing may be hollow and the tubing may be made from metal or other suitable material such as plastic. The tubing may or may not also have an internal seam. Further, tubing used with the described embodiments may be fabricated from metal which is formed into a tubular configuration with interlocking, overlapped layers defining an interior seam.

In FIG. 1, the components of a clamp 10 and their relationship to each other are shown. The clamp 10 assembly includes a handle 20, a saddle cam 26 which is shown as a nut located just under the handle 20, an upper plate 12, a lower plate 16, and a threaded receiver 24 shown as a lower nut 24. In use, the upper plate 12 and the lower plate 16 can be moved inwards towards each other using the handle 20 with the fastener 22 (which has an extended threaded portion) until the plates 12 and 16 are matingly engaged. The threaded fastener 22 is shown attached to the saddle nut 26, the lower nut 24, and the handle 20. Nut 24 is shown as the threaded receiver 24 in FIG. 1, and the nut 24 receives the fastener 22 and aids in urging the lower plate 16 towards the upper plate 12 so that the connector 10 can be secured around tubular member 28.

In this way, the lower plate 16 and the upper plate 12 together define a cooperating cavity which encircles the tube member 28 (not shown in FIG. 1) thereby holding it in place. In one embodiment, the action including the rotation of the handle 20 causes the lower plate 16 and the upper plate 12 to be increasingly axially engaged. This leads to a tight engagement with the exterior walls of the hollow tubed member 28. This inwardly radial force secures the perpendicular tube member 28 against the interior walls of the upper plate 12 and the lower plate 16. Thus, the handle 20, saddle nut 26 and fastener 22 act as a cam which aids in the engaging of the two plates. The cam ratio including the handle 20 size and the fastener 22 length can be set to allow a typical person to exert a sufficient amount of force to securely hold at least one tubular member 28 in the cavity formed between the two plates. Similarly, two tube members 28 may be joined together using the clamp 10 to exert force on the abutting ends of each tube member 28.

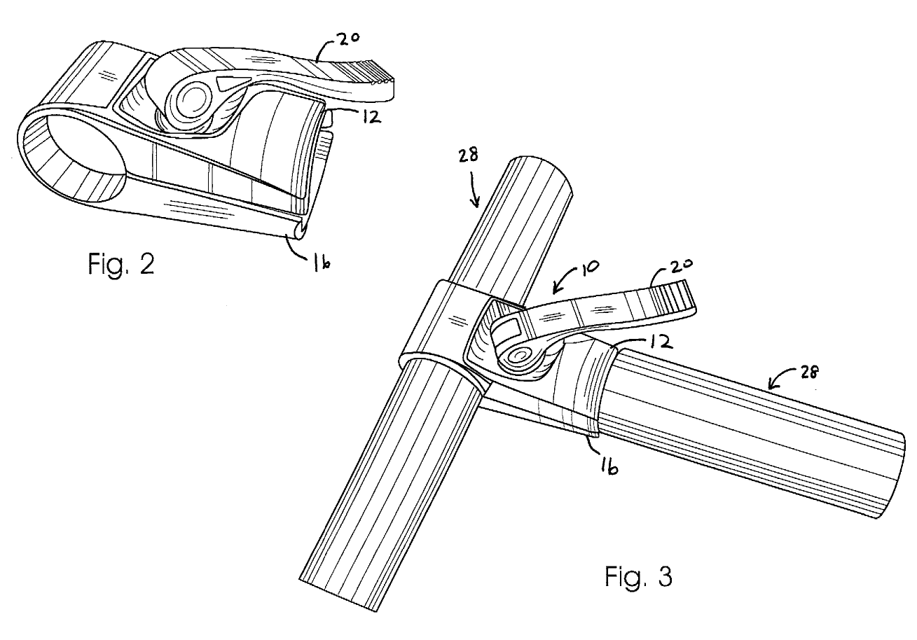

FIG. 2 illustrates an embodiment that has been axially engaged so that the upper plate 12 and the lower plate 16 are in a tight engagement. The interior surface of the cavity formed by the two plates is shaped in a curved configuration to accommodate the exterior walls of the tube member 28 which is not shown in FIG. 2.

Referring now to FIG. 3, the tube member 28 is shown within the cavity between the upper plate 12 and the lower plate 16. In this embodiment, the handle 20 has been first partially rotated and used as a cam means to engage the upper plate 12 and the lower plate 16. The handle 20 can then be depressed so that the handle 20 is in alignment with the first tubular member 28. This first tubular member 28 may also be integral to or a part of another structure or article. Clamp 10 can also be used to support, or be attached to, other components, such as a conventional structure, furniture, structure or article (not shown.)

In several embodiments, the fastener 22 is a threaded shank which is threadingly engaged to the saddle nut 26 and the threaded receiver 24. An upper aperture or cavity is provided at the top of the upper plate 12 in alignment with the lower aperture or cavity found at the bottom of the lower plate 16 and the fastener 22 is positioned through this cavity that extends through both the upper plate 12 and the lower plate 16.

Although not shown in FIGS. 2 and 3, the fastener 22 is positioned through the upper plate 12 and the lower plate 16 and the threaded receiver 24 is attached to the lower end of the threaded fastener 22. The receiver 24 may itself fit into a lower exterior cavity of the lower plate 16. This lower cavity acts both for receiving the threaded receiver 24 (such as the nut 24) and for limiting the axial movement of the threaded receiver 24 as well as the movement of the fastener 22 relative to the upper and lower plates.

As illustrated in FIG. 3, the upper plate 12 and the lower plate 16 are aligned with the fastener 22 and matingly engaged so as to form a cavity to accommodate the two tube members 28 which are oriented perpendicular to each other. In several embodiments, the threaded means 24 or nut 24 may be slid into the cavity of the lower plate 16 from the open side of the cavity. Although the threaded means 24 is illustrated as a separate nut 24 in FIG. 1, and as a removable, conventional component, it is to be understood that the lower plate 16 may be provided with threaded receiver 24 that is formed integral or unitary with the lower plate 16. However, in other embodiments the adjustability of the clamp 10 may be enhanced by providing a separate threaded receiver 24 or any other suitable receiving means.

The handle 20 may be additionally recessed to a complementary slot in the first tube member 28 or the second perpendicular tube member 28 once the plates 12 and 16 have been matingly engaged. However, when the clamp 10 components are in an untightened, loose position as illustrated in FIG. 1, the movement of the handle 20 is unrestricted. In use, a user may loosen and separate the clamp 10 from the one or more tube members 28 by rotating the handle 20 in the opposite, loosening direction until the tube member 28 is disengaged from interior surfaces of the plates 12 and 16.

To tighten, a user can rotated the handle 20 in the tightening direction to again effect a tight engagement between the interior surfaces of the two plates 12 and 16 and the exterior surface of the tube member 28. The handle 20 may be a cam locking type handle or it may be a simple control for a screw or it may be any other suitable mechanism used to secure the upper and lower plates. In the embodiments illustrated in FIGS. 1 through 3, the handle is rotated in order to screw the handle into the upper plate 12 and the lower plate 16 thereby tightening the upper plate 12 and the lower plate 16 and bringing the plates together. This means of adjustment can be used to position the handle 20 in a tightened configuration while it is extended, and then the handle 20 may be used as a lever to provide additional torque and resulting tightening of the clamp 10.

This lever action which can generate increased level of force using the handle/cam assembly has been well described and is well known in many other apparatuses, for instance cams used for making adjustments to bicycle seats. Any known handle/screw/cam element may be used to apply tension to the plates 12 and 16 so that inward force is applied to the exterior of the perpendicular tube member 28.

In this fashion, two tube members 28 may be connected together in an perpendicular or non linear direction from the outside of those tube members without having other exterior components to physically or visually obstruct the remaining apparatus components. In low profile embodiments, the handle 20 may also recess into the side of one of the tube members 28.

The illustrated embodiments of the clamp 10 may be constructed die cast aluminum, zinc, thermoplastic or any other suitable material. The nut 24, saddle nut 26 and the fastener 22 can be machined parts constructed of steel, plastic or any other suitable material.

The tube members 28 of the illustrated embodiments may also be constructed of any suitable size and dimension, for example, 1.250″ in outer diameter and 1.084″ in interior diameter. Clamp 10 may be fabricated to accommodate any sized tube member, and the range of the size of the fastener 22 may also be adjusted. Additionally, the dimensions of the plates 12 and 16 may be varied. They may also be fixed or they may be variable and adjustable, depending on the needs of the user and the application. For example, the distance between the plates may be variable so that the cavity is accommodating a specific diameter of a tube member 28. In another embodiment, the lower plate 12 and the upper plate 16 may be of differing dimensions. Other configurations will also be apparent to those persons skilled in the art.

The interior of the plates and/or the exterior surface of the tube members may also be coated with a substance such as rubber, Teflon or the like in order to increase the friction between the clamp 10 and the exterior of the tube members. Similarly, the exterior of the tube member 28 and/or the interior cavities of the plates 12 and 16 may also be made of a rough or knurled surface in order to increase the friction between the tube member 28 and the plates 12 and 16 resulting in increased holding power.

Other embodiments can use the plates and tube members fitted together in direct contact such as metal on metal or plastic on plastic. Additionally, anything that may be bonded to the surfaces of the plates and tube members can increase surface friction between the plates and the exterior surface of the hollow tube member and can lead to increased holding strength of the clamp.

In several embodiments, various alloys may be used to vary the strength of the plates. For a given alloy being used, such as aluminum, the cross section of the plates should be of sufficient size to handle the loads being applied by the levering of the handle 20.

The releasable attachment mechanism described in the present embodiments may also include a latch pin (not shown) positioned in transversely extending bores of the support base. The latch pin may be slideable between a released position wherein the tube clamp 10 can be detached/attached from the tube member 28 and a locked position wherein the clamp 10 cannot be so removed from the tube member 28. The embodiments also hold the tube members 28 so that they can be quickly released from the clamp 10 the quick release cam mechanism of the present invention.

Other embodiments of the present invention can use any known cam locking mechanism to apply pressure to a mechanism that holds the tube members 28 in a fixed position. These apparatuses may include vehicles, furniture, structures and wheelchairs.

While the claimed subject matter has been described with referenced to multiple embodiments, it should be understood by those skilled in the art that various changes and modifications may be made and equivalents may be substituted for elements thereof without departing from the scope of the claimed subject matter. Therefore, the claimed subject matter is not limited to the various disclosed embodiments including the best mode contemplated for carrying out the claimed subject matter, but instead includes all possible embodiments that fall under the subject matter to be claimed.

What is claimed is:

1. A quick release clamp for connecting a tubular section to another tubular section comprising:
an upper plate;
a lower plate;
a handle;
a threaded fastener; and
a threaded receiver;
wherein said handle and threaded fastener engage the upper plate, the lower plate and the threaded receiver so that the first tube section and the second tube section are secured within the clamp between the upper and lower plates in a perpendicular orientation relative to each other.

2. A quick release clamp for connecting a tubular section to another tubular section of claim 1 wherein the upper and lower plates are secured between the upper and lower plates in a non perpendicular angled orientation relative to each other.

3. A quick release clamp for connecting a tubular section to another tubular section of claim 1 wherein one of said tubular sections is another device or apparatus.

4. A quick release clamp for connecting a tubular section to another tubular section of claim 1 further comprising a securing fastener to hold the tubular sections in place.

5. A quick release clamp for connecting a tubular section to another tubular section of claim 1 wherein the handle can be recessed into the exterior of a tubular member.

6. A quick release clamp for connecting a tubular section to another tubular section of claim 1 wherein the exterior surface of said one or more tubular members is coated with a substance in order to increase the friction between the clamp and the one or more tubular members.

7. A quick release clamp for connecting a tubular section to another tubular section of claim 1 wherein the exterior surface of said upper surface plate or said lower plate is coated with a substance in order to increase the friction between the clamp and the one or more tubular members.

8. A quick release clamp for connecting a tubular section to another tubular section of claim 1 wherein said handle is recessed within a tubular member when said handle is not in use.

9. A quick release clamp for connecting a tubular section to another tubular section of claim 1 further comprising a releasable attachment mechanism having a latch pin positionable in transversely extending bores located though said upper plate and said lower plate.

10. A quick release clamp for connecting a tubular section to another tubular section of claim 9 wherein said latch pin is slideable between a released position and a locked position wherein said clamp cannot be detached from the tubular member.

11. A method of connecting a tubular section to another tubular section using a quick release clamp having
an upper plate;
a lower plate;
a handle;
a threaded fastener; and
a threaded receiver;
comprising the steps of
positioning said tubular sections within said upper plate and said lower plate; and
engaging said handle and threaded fastener so that the first tube section and the second tube section are secured within the clamp between the upper and lower plates in a perpendicular orientation relative to each other.

12. The method of connecting a tubular section to another tubular section using a quick release clamp of claim 11 wherein the upper and lower plates of said clamp are secured between the upper and lower plates in a non perpendicular angled orientation relative to each other.

13. The method of connecting a tubular section to another tubular section using a quick release clamp of claim 11 wherein one of said tubular sections is another device or apparatus.

14. The method of connecting a tubular section to another tubular section using a quick release clamp of claim 11 wherein said clamp further comprises a securing fastener to hold the tubular sections in place.

15. The method of connecting a tubular section to another tubular section using a quick release clamp of claim 11 wherein the handle of said clamp can be recessed into the exterior of a tubular member.

16. The method of connecting a tubular section to another tubular section using a quick release clamp of claim 11 wherein the exterior surface of said one or more tubular members is coated with a substance in order to increase the friction between the clamp and the one or more tubular members.

17. The method of connecting a tubular section to another tubular section using a quick release clamp of claim 11 wherein the exterior surface of said upper surface plate or said lower plate is coated with a substance in order to increase the friction between the clamp and the one or more tubular members.

18. The method of connecting a tubular section to another tubular section using a quick release clamp of claim 11 wherein said handle is recessed within a tubular member when said handle is not in use.

19. The method of connecting a tubular section to another tubular section using a quick release clamp of claim 1 wherein said clamp is further comprised of a releasable attachment mechanism having a latch pin positionable in transversely extending bores located though said upper plate and said lower plate.

20. The method of connecting a tubular section to another tubular section using a quick release clamp of claim 19 wherein said latch pin is slideable between a released position and a locked position wherein said clamp cannot be detached from the tubular member.

21. A system of connecting two or more tubular sections comprising a quick release clamp and two or more tubular sections using a quick release clamp, the quick release clamp comprising:
an upper plate;
a lower plate;
a handle;
a threaded fastener; and
a threaded receiver;
wherein said handle and threaded fastener engage the upper plate, the lower plate and the threaded receiver so that the first tube section and the second tube section are secured within the clamp between the upper and lower plates in a perpendicular orientation relative to each other.
